(19) United States
(12) Patent Application Publication
(10) Pub. No.: US 2026/0179185 A1
(43) Pub. Date: Jun. 25, 2026

(54) SYSTEM AND METHOD FOR IMPROVING TEMPORAL CONSISTENCY VIA FUSION TRACKING FILTER

(71) Applicant: Samsung Electronics Co., Ltd., Gyeonggi-do (KR)

(72) Inventors: Kee-Bong SONG, San Diego, CA (US); Mostafa EL-KHAMY, San Diego, CA (US); Oleg KHORUZHIY, San Diego, CA (US); Burhan Ahmad MUDASSAR, San Diego, CA (US); Prithvi SURESH, San Diego, CA (US); Hai SU, San Diego, CA (US); Qingfeng LIU, San Diego, CA (US)

(21) Appl. No.: 19/363,192

(22) Filed: Oct. 20, 2025

Related U.S. Application Data
(60) Provisional application No. 63/738,147, filed on Dec. 23, 2024.

(51) Int. Cl. G06T 5/50; G06T 5/20; G06T 5/60; G06V 10/26; G06V 10/36; G06V 10/774; G06V 10/82

(52) U.S. Cl. CPC G06T 5/50; G06T 5/20; G06T 5/60; G06V 10/26; G06V 10/36; G06V 10/774; G06V 10/82; G06T 2207/10016; G06T 2207/20081; G06T 2207/20084; G06T 2207/20221

(57) ABSTRACT

A system and a method are disclosed. The method includes extracting a plurality of video frames including at least a first frame and a second frame; generating a predicted soft volume for the second frame; generating a weight map of pixels for the first frame; combining the predicted soft volume for the second frame with the weight map of pixels for the first frame to generate combined predictions for the output frame; and generating a video including the combined predictions for the output frame.

### CROSS-REFERENCE TO RELATED APPLICATION

This application claims the priority benefit under 35 U.S.C. § 119(e) of U.S. Provisional Application No. 63/738,147, filed on Dec. 23, 2024, the entire contents of which are incorporated herein by reference.

### TECHNICAL FIELD

The disclosure generally relates to the field of video-based image processing and segmentation in neural networks. More particularly, the subject matter disclosed herein relates to improvements to temporal consistency mechanisms for generating high-quality pixel-level predictions across successive video frames.

### SUMMARY

Video-based pixel-level prediction tasks, such as semantic segmentation and instance segmentation, may be used in modern computer vision applications. These tasks may involve labeling each pixel in every frame of a video with semantic categories or instance identifications (IDs), which can include objects such as cars, people, or buildings. While deep neural networks (DNNs) have proven effective for single-image segmentation, their direct frame-by-frame application in videos may lead to temporal inconsistencies caused by small variations or shifts between consecutive frames. These inconsistencies, which may be triggered by factors such as slight camera or object motion may manifest as flickering when viewing the segmented frames in sequence.

To solve this problem, prior solutions have introduced motion estimation modules or optical flow calculations within the segmentation pipeline to align consecutive frames and reduce flicker. Some methods may also apply mechanisms to capture multi-frame contexts, or rely on smoothing through median or averaging filters. Although such techniques may address inconsistencies to a certain extent, they may depend heavily on accurate flow estimation, struggle with fast movements, or increase computational burdens significantly, often making them impractical for real-time or resource-constrained scenarios.

One issue with the above approaches is that large viewpoint shifts and rapid motion can degrade motion estimation or flow computation, leading to ghosting or lag in the segmented output. Furthermore, complex models that integrate attention or multi-frame alignment may demand considerable processing resources, creating an obstacle for efficient deployment on embedded devices or systems with limited computational power.

To overcome these issues, systems and methods are described herein for improving temporal consistency by learning or applying “fusion tracking” filters that combine a previous frame's segmentation predictions with the current frame's predictions. Rather than relying on explicit motion estimation, these mechanisms may operate at a per-pixel level to generate or compute multiplicative or additive operators that enhance consistency without introducing significant overhead or lag. In some embodiments, the model may learn parameters that regulate how the previous frame's soft volumes or log its may be adjusted and integrated with the current frame's output. In some embodiments, deterministic filters such as max-pooling or kernel-based weighting may be used.

The above approaches improve on previous methods because they do not rely on dedicated motion estimation pipelines that can be error-prone or computationally expensive when encountered with large or sudden movements in video frames. Moreover, the approaches disclosed herein may achieve relatively consistent frame-to-frame results without imposing significant overhead, making them well-suited for real-time deployment.

According to an aspect of the disclosure, a method includes extracting a plurality of video frames including at least a first frame and a second frame; generating a predicted soft volume for the second frame; generating a weight map of pixels for the first frame; combining the predicted soft volume for the second frame with the weight map of pixels for the first frame to generate combined predictions for the output frame; and generating a video including the combined predictions for the output frame.

According to another aspect of the disclosure, an apparatus includes a processor; and a memory coupled to the processor, wherein the processor is configured to extract a plurality of video frames including at least a first frame and a second frame; generate a predicted soft volume for the second frame; generate a weight map of pixels for the first frame; combine the predicted soft volume for the second frame with the weight map of pixels for the first frame to generate combined predictions for the output frame; and generate a video including the combined predictions from the output frame.

According to another aspect of the disclosure, a method includes extracting a plurality of video frames including at least a first frame and a second frame; generating predicted soft volumes for the first frame and the second frame; applying a filter configured to combine the predicted soft volumes for the first frame and the second frame using a trainable operator, thereby generating a fused output for at least one of the first frame or the second frame; generating a final output frame from the fused output; and generating a video including the final output frame.

According to another aspect of the disclosure, an apparatus includes a processor; and a memory coupled to the processor; wherein the processor is configured to extract a plurality of video frames including at least a first frame and a second frame; generate predicted soft volumes for the first frame and the second frame; apply a filter configured to combine the predicted soft volumes of the first frame and the second frame using a trainable operator, thereby generating a fused output for at least one of the first frame or the second frame; generate a final output frame from the fused output; and generate a video including the final output frame.

### BRIEF DESCRIPTION OF THE DRAWING

In the following section, the aspects of the subject matter disclosed herein will be described with reference to exemplary embodiments illustrated in the figures, in which:

FIG. 1 provides an example of semantic segmentation for images, according to an embodiment;

FIG. 2 is a system architecture for implementing fusion tracking to improve temporal consistency, according to an embodiment;

FIG. 3 is a block diagram illustrating a non-trainable tracking fusion filter, according to an embodiment;

FIG. 4 is a block diagram illustrating a recurrent training example in a trainable tracking fusion filter, according to an embodiment;

FIG. 5 is a block diagram illustrating a recurrent inference example with a trainable tracking fusion filter, according to an embodiment;

FIG. 6 is a block diagram illustrating a non-recurrent training example with a trainable tracking fusion filter, according to an embodiment;

FIG. 7 is a block diagram illustrating a non-recurrent inference example with a trainable tracking fusion filter, according to an embodiment;

FIG. 8 is a block diagram illustrating a recurrent training example with a trainable tracking fusion filter, according to an embodiment;

FIG. 9 is a block diagram illustrating a recurrent inference example with a trainable tracking fusion filter, according to an embodiment;

FIG. 10 is a block diagram illustrating a non-recurrent training example with a trainable tracking fusion filter, according to an embodiment;

FIG. 11 is a block diagram illustrating a non-recurrent inference example with a trainable tracking fusion filter, according to an embodiment;

FIG. 12 is a block diagram illustrating a recurrent training example with a trainable tracking fusion filter, according to an embodiment;

FIG. 13 is a block diagram illustrating a recurrent inference example with a trainable tracking fusion filter, according to an embodiment;

FIG. 14 is a block diagram illustrating a non-recurrent training example with a trainable tracking fusion filter, according to an embodiment;

FIG. 15 is a block diagram illustrating a non-recurrent inference example with a trainable tracking fusion filter, according to an embodiment;

FIG. 16 is a flowchart illustrating a method for improving temporal consistency via a non-learnable fusion tracking filter, according to an embodiment;

FIG. 17 is a flowchart illustrating a method for improving temporal consistency via a learnable fusion tracking filter, according to an embodiment;

FIG. 18 is a block diagram of an electronic device in a network, according to an embodiment; and

FIG. 19 is a block diagram illustrating a system including a UE and a network node, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

As used herein, the terms “first frame” and “second frame” may correspond respectively to two temporally adjacent frames within a sequence of video data. In some embodiments, the first frame may represent a previously processed or preceding frame (for example, a frame at time t−1), and the second frame may represent a current frame (for example, a frame at time t). The terms are intended as relative identifiers and may be used interchangeably with “previous frame” and “current frame,” depending on context. Unless otherwise indicated, references to operations performed on the first or second frame may apply to any temporally ordered pair of frames within a sequence.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Weight map” as used herein refers to a set of pixel-wise coefficients that selectively scale or emphasize specific regions within a frame or image. Some examples of “weight map” may be per-pixel confidence masks or multi-channel arrays derived from spatial filtering operations. In certain embodiments, the weight map may be generated by applying a spatial kernel or convolutional operation to one or more prediction channels of a soft volume, thereby producing per-pixel weighting values that reflect spatial relationships or motion continuity between consecutive frames. The generated weight map may then be applied to modify or linearly combine predictions from a first frame and a second frame (for example, a current frame (first frame) and a previous frame (second frame) (Note, the “first” and “second” frames can refer to any two frames (e.g., the first frame may be the previous frame, and the second frame may be the current frame)).

“Temporal consistency characteristic” as used herein refers to the degree of stability in the outputs produced across consecutive frames in a video sequence. Some examples of “temporal consistency characteristic” may be flicker reduction, label continuity in object boundaries, or minimal frame-to-frame jitter in segmentation maps.

“Spatial kernel” as used herein refers to a local neighborhood filter that processes portions of an image or frame, often defined by a shape or size parameter such as a kernel width or height. Some examples of “spatial kernel” may be max-pooling windows, averaging filters, or convolutional patches used to capture local structure or confidence within a region.

“Softmax” as used herein refers to a mathematical function that converts a set of real-valued inputs (e.g., log its) into a normalized probability distribution across multiple classes. Some examples of “Softmax” may be pixel-wise Softmax in semantic segmentation tasks and channel-wise Softmax applied within a neural network architecture.

“MaxPool” as used herein refers to a pooling operation that selects the maximum value within a local region or kernel in an image or feature map. Some examples of “MaxPool” may be two-dimensional max-pooling with a 3×3 kernel to identify the most dominant feature in each neighborhood, one-dimensional max-pooling for temporal or sequential data, and three-dimensional max-pooling for volumetric or spatiotemporal data.

“Argmax” as used herein refers to an operation that returns the position or index of the highest value in a given array or distribution. Some examples of “Argmax” may be pixel-wise class selection in a semantic segmentation output, selecting the most likely class in a multi-class classification, and identifying the peak value in a probability distribution over a set of labels.

“Soft volume” as used herein refers to a multi-channel prediction tensor that represents per-pixel confidence or likelihood values output by a segmentation network for a given frame. Each channel of the soft volume may correspond to a prediction channel or class, where the value at each spatial position indicates the model's estimated probability that the pixel belongs to that channel. The term “predicted soft volume” may therefore refer to the raw or normalized output of the network before a discrete label is assigned (for example, prior to applying an Argmax operation). In some embodiments, a plurality of soft volumes may be combined, filtered, or weighted across consecutive frames to improve temporal consistency, with each soft volume serving as an intermediate representation from which a final fused prediction can be derived.

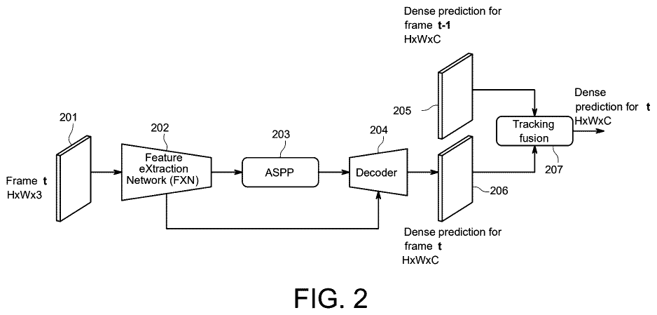

“Extraction” as used herein refers to the process of deriving one or more feature maps or intermediate representations from raw image or video data. For example, an extraction operation may involve applying convolutional, pooling, or normalization layers to transform pixel-level data into high-dimensional features suitable for downstream segmentation. Extraction may occur in the feature extraction network (FXN) at block 202 of FIG. 2, where pixel data of the input frame may be processed into feature maps that capture semantic and structural characteristics of the scene.

The present disclosure describes systems and methods for improving the temporal consistency of video-based pixel-level predictions, specifically within the context of video semantic segmentation.

Semantic segmentation may be defined as a task performed by an electronic device in which pixels of an image (or video frame) may be classified into a specific category or class. For example, every pixel that belongs to a car, a person, or a building may be labeled accordingly, resulting in a map where each region of the image corresponds to a particular semantic class. This differs from simpler recognition tasks, such as image classification (which assigns a single label per image), because semantic segmentation assigns a label to individual pixels, which may provide a more detailed understanding of scene content.

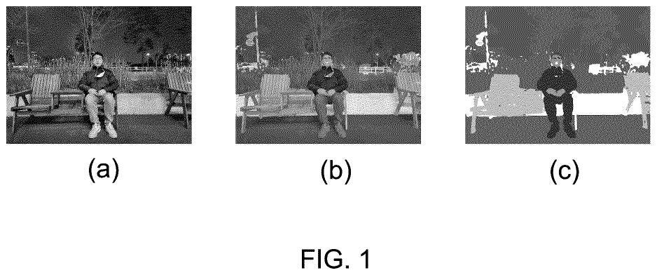

FIG. 1 provides an example of semantic segmentation for images, according to an embodiment.

Referring to FIG. 1, various classes of an image (e.g., chairs, trees, or sky) may be identified. As semantic segmentation may be performed, each of the classes may be assigned pixel values that show the separate classes as more pronounced and well defined from each other, thereby separating the image into the different classes. In (a) of FIG. 1, the baseline image may be provided. In (b) of FIG. 1, a first iteration of semantic segmentation may be performed. In (c) of FIG. 1, a second iteration of semantic segmentation may be performed. As each iteration of semantic segmentation may be performed, the values of the pixels for different classes may become more pronounced.

Video semantic segmentation may involve predicting the class of each pixel in each frame of a given video sequence. However, unlike single-image semantic segmentation, video semantic segmentation may account for each frame being part of a continuously changing sequence, often showing overlapping for slightly different views of the same scene. If each frame is segmented independently, small variations in object positions, lighting, or camera angles can cause inconsistent or “flickering” predictions when viewing the frames in rapid succession.

To address challenges related to maintaining consistent predictions across frames, the disclosure introduces a temporal fusion method that utilizes a fusion tracking block, which can be integrated as a plug-in component into various DNNs. This fusion tracking block may enhance the consistency of dense predictions generated for video inputs by processing both the current frame (which may also be referred to as a “first” or “second” frame) and the previous frames' (which may also be referred to as a “first” or “second” frame) prediction outputs. The fusion tracking block may operate by predicting one or more of a multiplicative operator or a weight map based on these two frames. The resulting operator or weight map may then be applied to adjust the current frame's predictions, ensuring that they align more consistently with the predictions from the previous frame, thereby improving the temporal stability of the segmentation results.

According to an embodiment, a non-trainable fusion tracking approach can use a multiplicative operator to obtain spatial information in each pixel of the neighboring frame's prediction to guide consistency. A spatial kernel, for instance a max-pooling or similar filter, can be applied to the neighboring frame to produce a weight map that highlights high-confidence regions. This weight map can be multiplied by the current frame's prediction, emphasizing stable or reliably segmented areas. The two predictions (the neighboring frame and the weighted current frame) can then be linearly combined using a fixed scalar weight. By substituting a raw neighboring frame prediction for a previously fused one, various embodiments disclosed herein can provide a flexible and computationally efficient mechanism for ensuring that segmentation results remain smooth from one frame to the next.

In addition to the non-trainable fusion tracking approach, a trainable variant is also described. According to an embodiment, the fusion tracking and adjustment of the current frame's prediction may rely on the prediction of a neighboring frame, such as the immediately preceding frame, rather than on a recursively fused frame. In particular, various embodiments of the present disclosure proposes fusion tracking mechanisms that may determine a multiplicative operator by examining both the current frame's prediction and that of a neighboring frame to improve temporal consistency. In one approach, the learned operator can be applied to the neighboring frame's prediction to transform it, so it aligns with the current frame, thereby reducing flicker or abrupt changes. Another variation may use a multiplicative operator to directly enhance the current frame's predictions, maintaining consistency even when a video scene undergoes rapid transformations. In addition, a weight map can be generated from the two frames' predictions, enabling a linear combination that may refine the current frame's output based on cues from the neighboring frame.

FIG. 2 is a system architecture for implementing fusion tracking to improve temporal consistency, according to an embodiment.

Referring to FIG. 2, a segmentation pipeline that may process a video frame at time t, may merge the frame with the previous frame's segmentation output, and may produce a temporally consistent dense prediction is shown.

At block 201, frame “t,” may denote the raw input image of size height×width×3 (H×W×3) pixels. This image may be fed into an FXN at block 202, which may represent a DNN for transforming the raw pixel data into feature maps that capture high-level semantic information. The FXN at block 202 may perform extraction to produce feature maps with high-level semantic information of the input frame. The extracted feature maps may then be provided to block 203 for atrous spatial pyramid pooling (ASPP), where parallel dilated convolutions may be used to gather contextual parameters at various scales. The ASPP block 203 may improve the network's ability to detect and segment objects of varying sizes within the frame.

After completing ASPP, the feature maps may be provided to the decoder at block 204, which may upsample or refine the multi-scale features to create dense predictions that match the spatial dimensions of the input (H×W×C, where C could represent the number of classes in a segmentation task). This initial dense prediction for frame t may represent a per-pixel probability or log it distribution belonging to a class, but may not yet account for consistency with prior frames. For example, if the system is trained to distinguish between classes of cars, people, and buildings, it may output, for each pixel, a value indicating how likely that pixel may be to be part of a car, a person, or a building.

Simultaneously, the system may provide a dense prediction for frame t−1 in block 205, having similar qualities as the dense prediction for frame t in block 206, but for the previous frame in the video sequence. Both the current frame's (t) dense prediction and the previous frame's (t-1) dense prediction may then be fed to the tracking fusion block 207. Here, the system integrates the data from blocks 205 and 206 to improve consistency over time.

For example, according to one or more embodiments, the fusion block 207 may involve learning a multiplicative or additive operator, applying spatial filters, or combining the two outputs through a weighted function. By referencing frame t−1's predictions, the system can reduce flicker for objects that persist across consecutive frames.

The output of this fusion block 207 may be labeled “dense prediction for t,” shown at an output size of H×W×C. In some implementations, the number of channels (C) may be three and may correspond to a red green blue (RGB) visualization of the segmentation map, or they may represent a condensed three-channel representation suitable for display or subsequent refinement. Although three channels are described in this example, more or less could be used. Accordingly, temporally coherent segmentation results (predictions) for a continuous video stream may be obtained using the current frame and the previous frame.

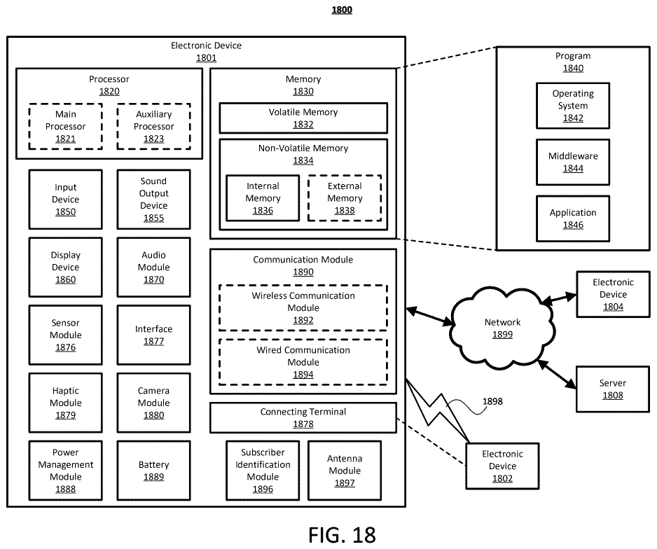

Furthermore, the predictions may be used to generate a video locally on a device that performs one or more of the blocks in FIG. 2 (e.g., device 1801, 1802, or 1804 of FIG. 18), or may be transmitted (e.g., via a communication module 1890) to another device that generates the video. In some implementations, the video generation process performed by device 1801, 1802, and/or 1804 of FIG. 18 may be performed under control of the processor 1820 executing program 1840 stored in memory 1830, which may coordinate retrieval of the fused predictions and may sequentially compose the fused predictions into a temporally coherent video stream. The resulting video, or its intermediate frames, may be displayed through display 1860 or stored in storage 1850 for subsequent playback or analysis. Optionally, communication module 1890 may transmit the generated video or segmentation metadata to another system for post-processing or refinement, as described in connection with FIG. 18.

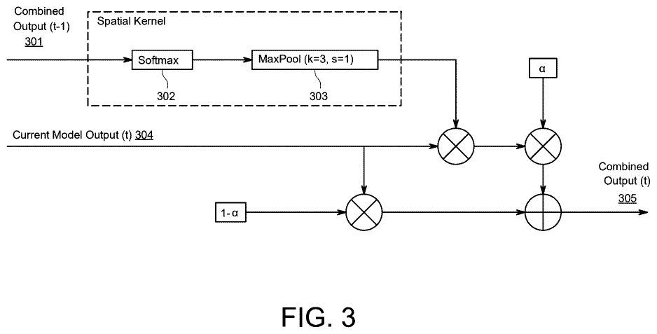

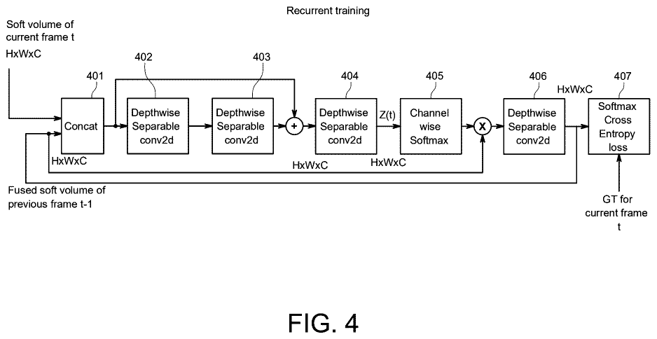

Various embodiments can be applied jointly to the same model. For example, the model shown in FIG. 3, below can be applied as a postprocessing fusion tracking filter, and one or more of the models described in FIGS. 4-15, below, can be implemented as learnable counterparts.

According to an embodiment, a non-trainable tracking fusion filter may be implemented as a post-processing step without training.

FIG. 3 is a block diagram illustrating a non-trainable tracking fusion filter, according to an embodiment.

Referring to FIG. 3, the combined output from the previous frame (t-1) 301 may be fed into a spatial kernel, which may include two operations. First, a Softmax operation at block 302 may normalize the un-normalized log its (or probabilities) so that each pixel's values lie within a consistent range. Next, at block 303, a MaxPool (max-pooling) step with a specified kernel size (for example, k=3, stride=1) may assign a higher weight to pixels to more confidently predict classes (or objects) within a local region (or pixel group). This process in block step 303 may therefore spatially filter a plurality of prediction channels to obtain soft volume predictions. For example, if a class is present in neighboring pixels, then a higher weight value of that class may be assigned to a given pixel. The result of these two steps may be a per-pixel weight map for the previous frame, which may ensure that high-confidence areas from the previous frame guide the segmentation process in the current frame.

The model output of the current frame t 304 may by predictions that represent the un-normalized or partially normalized log its for the given frame. This current frame output may be multiplied (combined) by the weight map of pixels for the previous frame output from block 303 to emphasize predictions that align with the previous frame's regions of highest confidence that objects in the previous frame may be consistent with the current frame. The intermediate product may then enter a multiplier where it may be scaled by a factor α (alpha), which may determine how strongly the previous frame's information influences the current frame. Simultaneously, the previous frame's combined output may also be scaled by (1-α). These two scaled terms may be merged (summed) to produce predictions for the combined output (t) 305. This combined output may serve as a segmentation map for the current frame and may also be stored for use when processing the next frame to improve temporal consistency across consecutive video frames.

In some embodiments, rather than a single fixed scalar a applied globally across the frame, a per-pixel scalar weight may be generated to modulate the relative contribution of the previous frame and the current frame on a pixel-by-pixel basis. Each pixel's scalar weight may be computed based on local confidence or motion cues extracted from the corresponding soft volumes. The resulting spatially varying weights may be fused in regions of rapid motion or occlusion, allowing high-confidence areas from the first frame to stabilize predictions of the second frame.

According to an embodiment, a trainable tracking fusion filter may be implemented with trainable parameters.

FIG. 4 is a block diagram illustrating a recurrent training example with a trainable tracking fusion filter, according to an embodiment.

During recurrent training, the system may take both the current frame's (t) predicted soft volume and the fused soft volume from the previous frame (t-1) and may merge them to generate a multiplicative operator Z(t). This may involve concatenating the two soft volumes at block 401 and performing depthwise separable convolution at blocks 402 and 403. The result may be summed with the concatenated output of block 401, and then convolved again at block 404. The result may be Z(t).

A Softmax function may then be applied to this operator Z(t) at block 405, which may then be multiplied by the previously fused prediction and may be convolved again at block 406, effectively transforming it into a prediction consistent with the current frame. To ensure the transformed prediction remains accurate, a Softmax cross-entropy loss may be computed between it and the ground truth (GT) for the current frame at block 407.

Accordingly, FIG. 4 may illustrate how the network learns an operator Z(t) from both the current and prior frame predictions. That operator may then be applied to the current frame's output, producing a stable, flicker-free segmentation across consecutive frames.

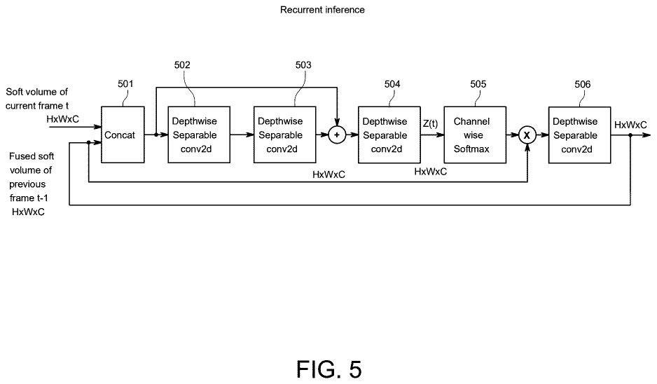

FIG. 5 is a block diagram illustrating a recurrent inference example with a trainable tracking fusion filter, according to an embodiment.

For clarity and ease of understanding, the descriptions of certain features, steps, or functions shown in blocks 501-506 of FIG. 5 may not be described repeatedly. The descriptions of such elements may be obtained by respectively referring to the descriptions of blocks 401-406 of FIG. 4, without detracting from the scope or spirit of the present disclosure.

Referring to FIG. 5, the system may take both the current frame's (t) predicted soft volume and the fused soft volume from the previous frame (t-1) and may merge them to generate a multiplicative operator Z(t). This may involve concatenating the two soft volumes at block 501 and performing depthwise separable convolution at blocks 502 and 503. The result may be summed with the concatenated output of block 501, and then convolved again at block 504. The result may be Z(t).

A Softmax function may then be applied to this operator Z(t) at block 505, which may then be multiplied by the previously fused prediction and may be convolved again at block 506.

At recurrent inference, the last fused output (the soft volume of class probabilities at t−1) may be passed into the fusion block alongside the current frame's soft volume (e.g., H×W×C). The fusion block may produce a new fused output for the current frame (at time t), ensuring continuity between frames without recomputing the entire training procedure.

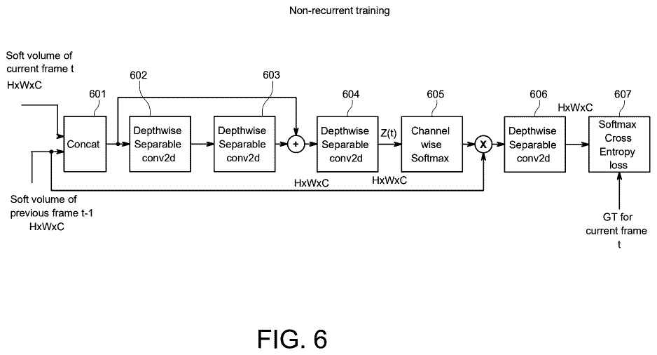

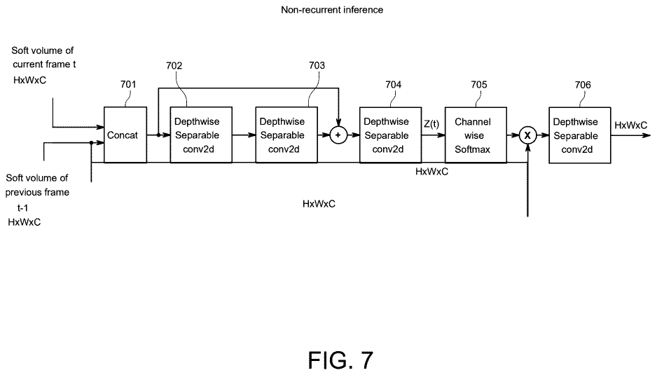

FIG. 6 is a block diagram illustrating a non-recurrent training example with a trainable tracking fusion filter, according to an embodiment. FIG. 7 is a block diagram illustrating a non-recurrent inference example with a trainable tracking fusion filter, according to an embodiment.

For clarity and ease of understanding, the descriptions of certain features, steps, or functions shown in blocks 601-607 of FIG. 6 and 701-706 of FIG. 7 may not be described repeatedly. The descriptions of such elements may be obtained by respectively referring to the descriptions of blocks 401-407 of FIG. 4 and 501-506 of FIG. 5, without detracting from the scope or spirit of the present disclosure.

Referring to FIG. 6, the system may take both the current frame's (t) predicted soft volume and the fused soft volume from the previous frame (t-1) and may merge them to generate a multiplicative operator Z(t). This may involve concatenating the two soft volumes at block 601 and performing depthwise separable convolution at blocks 602 and 603. The result may be summed with the concatenated output of block 601, and then convolved again at block 604. The result may be Z(t).

A Softmax function may then be applied to this operator Z(t) at block 605, which may then be multiplied by the previously fused prediction and may be convolved again at block 606, effectively transforming it into a prediction consistent with the current frame. To ensure the transformed prediction remains accurate, a Softmax cross-entropy loss may be computed between it and the GT for the current frame at block 607.

Referring to FIG. 7, the system may take both the current frame's (t) predicted soft volume and the fused soft volume from the previous frame (t-1) and may merge them to generate a multiplicative operator Z(t). This may involve concatenating the two soft volumes at block 701 and performing depthwise separable convolution at blocks 702 and 703. The result may be summed with the concatenated output of block 701, and then convolved again at block 704. The result may be Z(t).

A Softmax function may then be applied to this operator Z(t) at block 705, which may then be multiplied by the previously fused prediction and may be convolved again at block 706.

Referring to FIGS. 6-7, a non-recurrent implementation of this approach may follow the same fusion concept as FIGS. 4-5 but does not rely on the previously fused output from the last time step. Instead, the system may use the soft volume produced by the model before the fusion-based correction takes place. Accordingly, this change in input source may differentiate the non-recurrent method from the fully recurrent training and inference schemes.

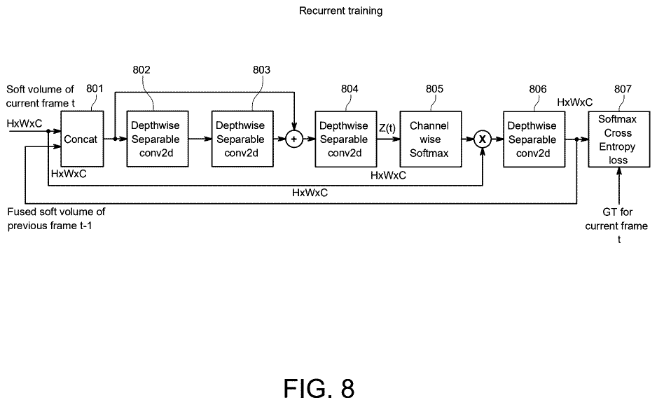

FIG. 8 is a block diagram illustrating a recurrent training example with a trainable tracking fusion filter, according to an embodiment.

For clarity and ease of understanding, the descriptions of certain features, steps, or functions shown in blocks 801-807 of FIG. 8 may not be described repeatedly. The descriptions of such elements may be obtained by respectively referring to the descriptions of blocks 401-407 of FIG. 4, without detracting from the scope or spirit of the present disclosure.

Referring to FIG. 8, the system may take both the current frame's (t) predicted soft volume and the fused soft volume from the previous frame (t-1) and may merge them to generate a multiplicative operator Z(t). This may involve concatenating the two soft volumes at block 801 and performing depthwise separable convolution at blocks 802 and 803. The result may be summed with the concatenated output of block 801, and then convolved again at block 804. The result may be Z(t).

A Softmax function may then be applied to this operator Z(t) at block 805, which may then be multiplied by the previously fused prediction and may be convolved again at block 806, effectively transforming it into a prediction consistent with the current frame. To ensure the transformed prediction remains accurate, a Softmax cross-entropy loss may be computed between it and the GT for the current frame at block 807.

In a recurrent training setup, the soft volume of the current frame and the fused soft volume from the previous frame (t-1) may be merged to produce a multiplicative operator Z(t). This operator may then be applied to the current frame's prediction so that it aligns with the previous frame's segmentation. To verify that the resulting adjusted prediction remains accurate, the system may compute a Softmax cross-entropy loss between it and the current frame's ground truth labels.

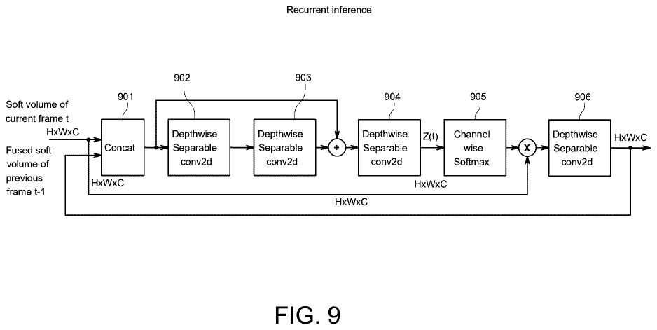

FIG. 9 is a block diagram illustrating a recurrent inference example with a trainable tracking fusion filter, according to an embodiment.

For clarity and ease of understanding, the descriptions of certain features, steps, or functions shown in blocks 901-906 of FIG. 9 may not be described repeatedly. The descriptions of such elements may be obtained by respectively referring to the descriptions of blocks 801-806 of FIG. 8, without detracting from the scope or spirit of the present disclosure.

Referring to FIG. 9, the system may take both the current frame's (t) predicted soft volume and the fused soft volume from the previous frame (t-1) and may merge them to generate a multiplicative operator Z(t). This may involve concatenating the two soft volumes at block 901 and performing depthwise separable convolution at blocks 902 and 903. The result may be summed with the concatenated output of block 901, and then convolved again at block 904. The result may be Z(t).

A Softmax function may then be applied to this operator Z(t) at block 905, which may then be multiplied by the previously fused prediction and may be convolved again at block 906.

In a recurrent inference setup, the last fused output (soft volume at t−1) may be brought into the fusion block together with the current frame's soft volume. The two inputs may be fused into a final segmentation for frame t, such that the fused output may retain spatial cues from the previous frame. Through this process, the model may propagate feature information across consecutive frames, allowing each fused output to incorporate data not only from the immediately preceding frame but also from earlier frames through recurrent connections, which may be preserve temporal consistency throughout the video sequence, without requiring any additional training steps.

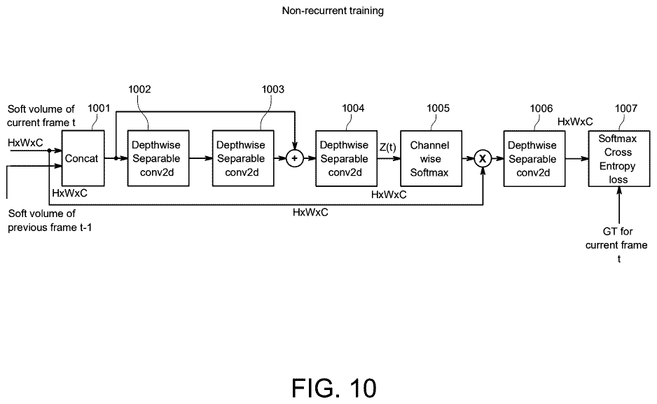

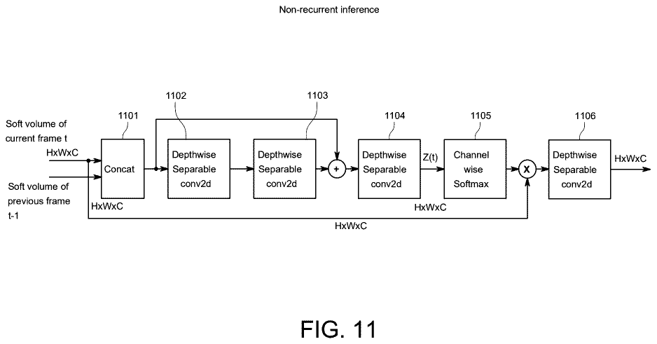

FIG. 10 is a block diagram illustrating a non-recurrent training example with a trainable tracking fusion filter, according to an embodiment. FIG. 11 is a block diagram illustrating a non-recurrent inference example with a trainable tracking fusion filter, according to an embodiment.

For clarity and ease of understanding, the descriptions of certain features, steps, or functions shown in blocks 1001-1007 of FIG. 10 and 1101-1106 of FIG. 11 may not be described repeatedly. The descriptions of such elements may be obtained by respectively referring to the descriptions of blocks 801-807 FIGS. 8 and 901-906 of FIG. 9, without detracting from the scope or spirit of the present disclosure.

Referring to FIG. 10, the system may take both the current frame's (t) predicted soft volume and the fused soft volume from the previous frame (t-1) and may merge them to generate a multiplicative operator Z(t). This may involve concatenating the two soft volumes at block 1001 and performing depthwise separable convolution at blocks 1002 and 403. The result may be summed with the concatenated output of block 1001, and then convolved again at block 1004. The result may be Z(t).

A Softmax function may then be applied to this operator Z(t) at block 1005, which may then be multiplied by the previously fused prediction and may be convolved again at block 1006, effectively transforming it into a prediction consistent with the current frame. To ensure the transformed prediction remains accurate, a Softmax cross-entropy loss may be computed between it and the GT for the current frame at block 1007.

Referring to FIG. 11, the system may take both the current frame's (t) predicted soft volume and the fused soft volume from the previous frame (t-1) and may merge them to generate a multiplicative operator Z(t). This may involve concatenating the two soft volumes at block 1101 and performing depthwise separable convolution at blocks 1102 and 1103. The result may be summed with the concatenated output of block 1101, and then convolved again at block 1104. The result may be Z(t).

A Softmax function may then be applied to this operator Z(t) at block 1105, which may then be multiplied by the previously fused prediction and may be convolved again at block 1106.

Referring to FIGS. 10-11, in a non-recurrent implementation, the fusion module may function similarly to FIGS. 8-9, but rather than relying on the previously fused output, it may use the raw soft volume produced by the model for the previous frame. In other words, the system may no longer reuse the fused prediction across frames, but it may still apply the same principle of merging two consecutive frames' outputs to improve consistency from one frame to the next.

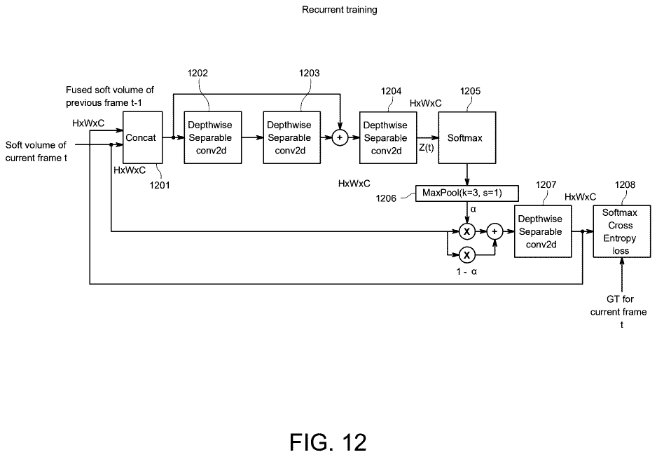

FIG. 12 is a block diagram illustrating a recurrent training example with a trainable tracking fusion filter, according to an embodiment.

For clarity and ease of understanding, the descriptions of certain features, steps, or functions shown in blocks 1201-1208 of FIG. 12 may not be described repeatedly. The descriptions of blocks 1201-1205 and 1207-1208 may be obtained by respectively referring to the descriptions of blocks 401-407 of FIG. 4, without detracting from the scope or spirit of the present disclosure.

Referring to FIG. 12, which illustrates recurrent training, the system may take both the current frame's (t) predicted soft volume and the fused soft volume from the previous frame (t-1) and may merge them to generate a multiplicative operator Z(t). This may involve concatenating the two soft volumes at block 1201 and performing depthwise separable convolution at blocks 1202 and 1203. The result may be summed with the concatenated output of block 1201, and then convolved again at block 1204. The result may be Z(t).

A Softmax function may then be applied to this operator Z(t) at block 1205, which may then be multiplied by the previously fused prediction and may be convolved again at block 1207. To ensure the transformed prediction remains accurate, a Softmax cross-entropy loss may be computed between it and the GT for the current frame at block 1208.

The system of FIG. 12 processes both the current frame's (t) soft volume and the fused soft volume from the previous frame (t-1) to produce an operator Z(t). This operator may be used to enhance the current frame's (t) predictions so they align with the prior fused results by applying a MaxPool function in block 1206. In particular, the model may combine α*MaxPool(SoftMax(Z(t))) and (1−α)*Predcurrent(t) according to Equation 1:

$${Pred}_{combined} ( t ) = Argmax ( Conv 2 D ( α * MaxPool ( SoftMax ( Z ( t ) ) ) + ( 1 - α ) * {Pred}_{current} ( t ) ) ) \qquad Equation l$$

where α is a learnable parameter that balances the contribution of Z(t) against the original predictions for the current frame. After these terms may be summed and passed through a convolution function (Conv2D), an argmax function (Argmax) can be applied to select the most probable class per pixel. Then, at block 1208, a Softmax cross-entropy loss may be computed between the enhanced prediction and the ground truth for the current frame. The computation may produce a temporally consistent prediction while maintaining accuracy across frames. In some embodiments, the overall accuracy of the enhanced prediction after block 1208 compared to the baseline prediction may remain substantially unchanged, while the temporal stability of the outputs may be improved.

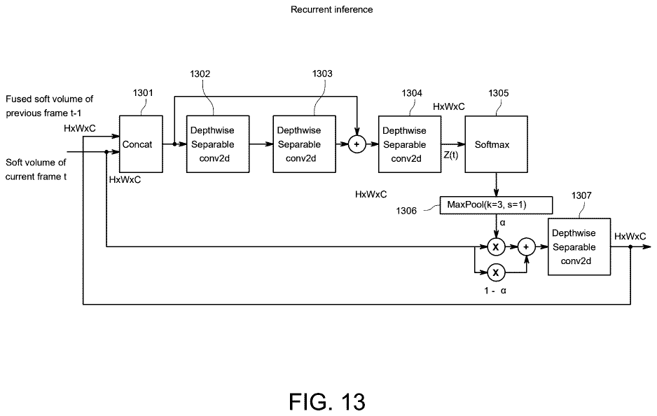

FIG. 13 is a block diagram illustrating a recurrent inference example with a trainable tracking fusion filter, according to an embodiment.

For clarity and ease of understanding, the descriptions of certain features, steps, or functions shown in blocks 1301-1307 of FIG. 13 may not be described repeatedly. The descriptions of such elements may be obtained by respectively referring to the descriptions of blocks 1201-1207 of FIG. 12, without detracting from the scope or spirit of the present disclosure.

Referring to FIG. 13, for recurrent inference, the system may take both the current frame's (t) predicted soft volume and the fused soft volume from the previous frame (t-1) and may merge them to generate a multiplicative operator Z(t). This may involve concatenating the two soft volumes at block 1301 and performing depthwise separable convolution at blocks 1302 and 1303. The result may be summed with the concatenated output of block 1301, and then convolved again at block 1304. The result may be Z(t).

A Softmax function may then be applied to this operator Z(t) at block 1305, which may then be multiplied by the previously fused prediction and may be convolved again at block 1307.

The system of FIG. 13 may input the fused output of the previous frame (t-1) along with the current frame's (t) predictions. It may use the same learned blending mechanism described in FIG. 12 to create a fused soft volume for time t by applying a MaxPool function in block 1306. Because this can occur after training, the system may operate the fusion procedure (including MaxPool (SoftMax(Z(t)), and apply the learned parameter a without computing a loss. The final output for the current frame may become the new fused soft volume, which may then be available for the subsequent frame.

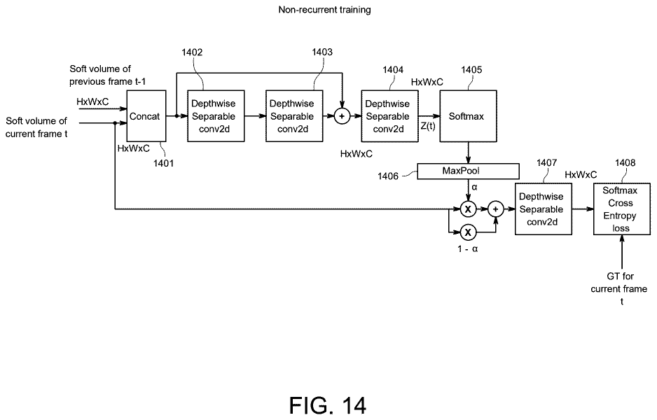

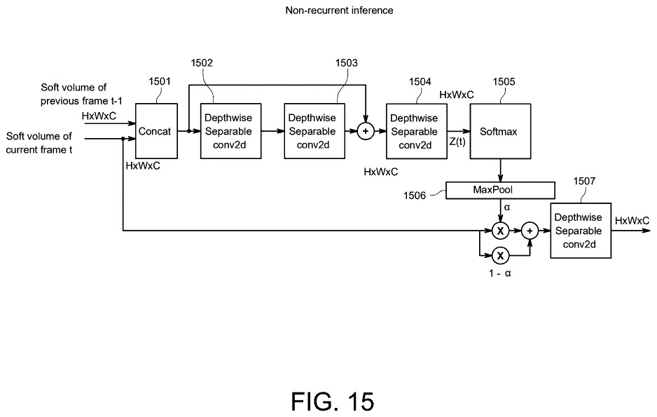

FIG. 14 is a block diagram illustrating a non-recurrent training example with a trainable tracking fusion filter, according to an embodiment. FIG. 15 is a block diagram illustrating a non-recurrent inference example with a trainable tracking fusion filter, according to an embodiment.

For clarity and ease of understanding, the descriptions of certain features, steps, or functions shown in blocks 1401-1408 of FIG. 14 and 1501-1507 of FIG. 15 may not be described repeatedly. The descriptions of such elements may be obtained by respectively referring to the descriptions of blocks 1201-1208 FIGS. 12 and 1301-1307 of FIG. 13, without detracting from the scope or spirit of the present disclosure.

Referring to FIG. 14, the system may take both the current frame's (t) predicted soft volume and the fused soft volume from the previous frame (t-1) and may merge them to generate a multiplicative operator Z(t). This may involve concatenating the two soft volumes at block 1401 and performing depthwise separable convolution at blocks 1402 and 1403. The result may be summed with the concatenated output of block 1401, and then convolved again at block 1404. The result may be Z(t).

A Softmax function may then be applied to this operator Z(t) at block 1405, which may then be multiplied by the previously fused prediction and may be convolved again at block 1407, effectively transforming it into a prediction consistent with the current frame. To ensure the transformed prediction remains accurate, a Softmax cross-entropy loss may be computed between it and the GT for the current frame at block 1408.

Referring to FIG. 15, the system may take both the current frame's (t) predicted soft volume and the fused soft volume from the previous frame (t-1) and may merge them to generate a multiplicative operator Z(t). This may involve concatenating the two soft volumes at block 1501 and performing depthwise separable convolution at blocks 1502 and 1503. The result may be summed with the concatenated output of block 1501, and then convolved again at block 1504. The result may be Z(t).

A Softmax function may then be applied to this operator Z(t) at block 1505, which may then be multiplied by the previously fused prediction and may be convolved again at block 1507.

Referring to FIGS. 14-15, the non-recurrent system processes both the current frame's (t) soft volume and the fused soft volume from the previous frame (t-1) to produce an operator Z(t). This operator may be used to enhance the current frame's (t) predictions so they align with the prior fused results by applying a MaxPool function in block 1406. Similarly, in FIG. 15, the operator may be used to enhance the current frame's (t) predictions so they align with the prior fused results by applying a MaxPool function in block 1506.

However, unlike FIGS. 12-13, in a non-recurrent setting, depicted in FIG. 14 for training and FIG. 15 for inference, the previous frame's (t-1) raw prediction may be used instead of the previously fused soft volume. Rather than carrying forward the fused result from frame to frame, the model may incorporate the unmodified soft volume from the prior frame, producing an operator Z(t) to transform and refine the current frame's predictions. This may eliminate the feedback loop inherent to the recurrent scheme while retaining the basic principle of combining two consecutive frames to boost temporal consistency.

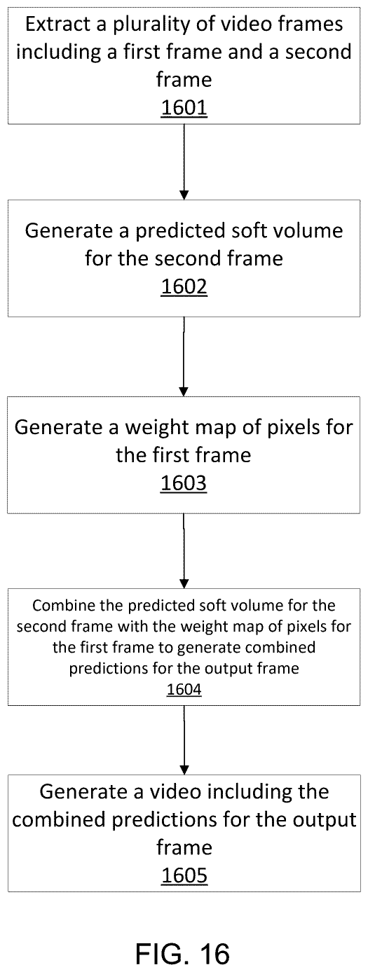

FIG. 16 is a flowchart illustrating a method for improving temporal consistency via a non-learnable fusion tracking filter, according to an embodiment.

The steps described with respect to FIG. 16 may be performed by one or more electronic devices, such as the device 1801, 1802, 1804, or the processor 1820 of FIG. 18, and may be executed in parallel, sequentially, or in a different order than shown.

Referring to FIG. 16, in step 1601, a plurality of video frames may be extracted, including at least a first frame and a second frame. The extraction may involve receiving or decoding image data from a live video stream, a buffered sequence, or a stored media file. In some embodiments, extraction may include preprocessing operations such as resizing or frame alignment. The extracted frames may then serve as inputs to subsequent modules that generate pixel-wise predictions.

In step 1602, a predicted soft volume may be generated for the second frame. The predicted soft volume may represent per-pixel confidence or log it distributions prior to temporal fusion.

In step 1603, a weight map of pixels may be generated for the first frame. The weight map may be derived by spatially filtering a plurality of prediction channels in the first frame's soft volume, generating per-pixel weighting coefficients that represent spatial or temporal consistency.

In step 1604, the predicted soft volume for the second frame may be combined with the weight map of pixels for the first frame to generate combined predictions for the output frame. The combination may include a linear weighting or multiplicative operation.

In step 1605, a video including the combined predictions may be generated. The generation may occur locally on an electronic device or remotely through a communication module.

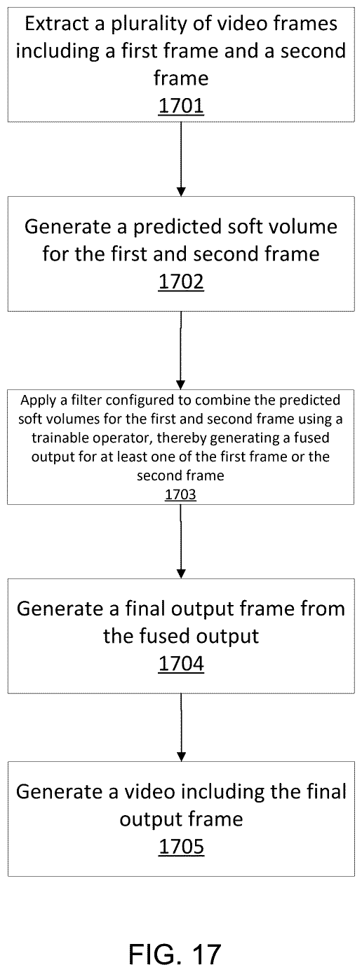

FIG. 17 is a flowchart illustrating a method for improving temporal consistency via a learnable fusion tracking filter, according to an embodiment.

The steps described with respect to FIG. 17 may be performed by one or more electronic devices, such as the device 1801, 1802, 1804, or the processor 1820 of FIG. 18, and may be executed in parallel, sequentially, or in a different order than shown.

Referring to FIG. 17, in step 1701, a plurality of video frames may be extracted, including at least a first frame and a second frame. The extraction may involve receiving or decoding image data from a live video stream, a buffered sequence, or a stored media file. In some embodiments, extraction may include preprocessing operations such as resizing or frame alignment. The extracted frames may then serve as inputs to subsequent modules that generate pixel-wise predictions.

In step 1702, predicted soft volumes may be generated for the first frame and the second frame. Each soft volume may include per-pixel probabilities across multiple segmentation classes.

In step 1703, a learnable fusion tracking filter may be applied to combine the predicted soft volumes using a trainable operator. The operator may be a multiplicative mapping (Z(t)) computed by one or more depthwise separable Conv2D layers and normalized via Softmax. The fused output may represent a temporally aligned prediction that incorporates contextual cues from the first frame and the second frame.

In step 1704, a final output frame may be generated from the fused output. Additional convolutional or normalization layers may refine the fused representation prior to visualization or storage.

In step 1705, a video including the final output frame may be generated, locally or remotely.

FIG. 18 is a block diagram of an electronic device in a network, according to an embodiment.

Referring to FIG. 18, an electronic device 1801 in a network environment 1800 may communicate with an electronic device 1802 via a first network 1898 (e.g., a short-range wireless communication network), or an electronic device 1804 or a server 1808 via a second network 1899 (e.g., a long-range wireless communication network). The electronic device 1801 may communicate with the electronic device 1804 via the server 1808. The electronic device 1801 may include a processor 1820, a memory 1830, an input device 1850, a sound output device 1855, a display device 1860, an audio module 1870, a sensor module 1876, an interface 1877, a haptic module 1879, a camera module 1880, a power management module 1888, a battery 1889, a communication module 1890, a subscriber identification module (SIM) card 1896, or an antenna module 1897. In one embodiment, at least one (e.g., the display device 1860 or the camera module 1880) of the components may be omitted from the electronic device 1801, or one or more other components may be added to the electronic device 1801. Some of the components may be implemented as a single IC. For example, the sensor module 1876 (e.g., a fingerprint sensor, an iris sensor, or an illuminance sensor) may be embedded in the display device 1860 (e.g., a display).

The processor 1820 may execute software (e.g., a program 1840) to control at least one other component (e.g., a hardware or a software component) of the electronic device 1801 coupled with the processor 1820 and may perform various data processing or computations.

Embodiments disclosed herein utilize the structural components of FIG. 18 to implement the fusion tracking mechanisms described in this application, enabling efficient and accurate video semantic segmentation on resource-constrained devices (e.g., smartphones, tablets, or similar electronic devices). For example, the camera module 1880 may capture an incoming stream of video frames, which may then be processed by the processor 1820 to apply the non-trainable or trainable fusion tracking filter. By using this fusion approach, temporal consistency may be improved, leading to more stable segmentation results from frame to frame.

The memory 1830 may store the various neural network components, trainable parameters, and intermediate outputs (such as soft volumes and fused predictions) required to execute or refine the segmentation operations. In addition, the memory 1830 can hold historical context about previously fused frames, which helps the processor 1820 align new predictions with prior outputs and maintain continuity throughout the video sequence. This local storage strategy allows the electronic device 1801 to achieve real-time or near real-time performance without relying on cloud-based resources.

Further, the display device 1860 may be used to present the resulting segmentation outputs to the user, such as color-coded overlays that highlight different classes (for example, roads, pedestrians, vehicles, or any other segment of interest). Or, the final result may be an image or video with reduced flickering because the pixels have been segmented by class using the fusion tracking mechanism described herein.

Accordingly, by incorporating these improvements, an end user may witness smooth transitions and minimal flicker between frames, even in dynamic scenes involving rapid motion or frequent viewpoint changes. The communication module 1890 may provide connectivity to external servers 1808 or other devices 1802/1804, enabling updates to the fusion tracking parameters, synchronization of segmented video outputs, or additional data exchange that supports adaptive learning and more robust segmentation models.

As at least part of the data processing or computations, the processor 1820 may load a command or data received from another component (e.g., the sensor module 1876 or the communication module 1890) in volatile memory 1832, process the command or the data stored in the volatile memory 1832, and store resulting data in non-volatile memory 1834. The processor 1820 may include a main processor 1821 (e.g., a central processing unit (CPU) or an application processor (AP)), and an auxiliary processor 1823 (e.g., a graphics processing unit (GPU), an image signal processor (ISP), a sensor hub processor, or a communication processor (CP)) that is operable independently from, or in conjunction with, the main processor 1821. Additionally or alternatively, the auxiliary processor 1823 may be adapted to consume less power than the main processor 1821, or execute a particular function. The auxiliary processor 1823 may be implemented as being separate from, or a part of, the main processor 1821.

The auxiliary processor 1823 may control at least some of the functions or states related to at least one component (e.g., the display device 1860, the sensor module 1876, or the communication module 1890) among the components of the electronic device 1801, instead of the main processor 1821, while the main processor 1821 is in an inactive (e.g., sleep) state, or together with the main processor 1821 while the main processor 1821 is in an active state (e.g., executing an application). The auxiliary processor 1823 (e.g., an image signal processor or a communication processor) may be implemented as part of another component (e.g., the camera module 1880 or the communication module 1890) functionally related to the auxiliary processor 1823.

The memory 1830 may store various data used by at least one component (e.g., the processor 1820 or the sensor module 1876) of the electronic device 1801. The various data may include, for example, software (e.g., the program 1840) and input data or output data for a command related thereto. The memory 1830 may include the volatile memory 1832 or the non-volatile memory 1834. Non-volatile memory 1834 may include internal memory 1836 and/or external memory 1838.

The program 1840 may be stored in the memory 1830 as software, and may include, for example, an operating system (OS) 1842, middleware 1844, or an application 1846.

The input device 1850 may receive a command or data to be used by another component (e.g., the processor 1820) of the electronic device 1801, from the outside (e.g., a user) of the electronic device 1801. The input device 1850 may include, for example, a microphone, a mouse, or a keyboard.

The sound output device 1855 may output sound signals to the outside of the electronic device 1801. The sound output device 1855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1860 may visually provide information to the outside (e.g., a user) of the electronic device 1801. The display device 1860 may include, for example, a display, a hologram device, or a projector and control circuitry to control a corresponding one of the display, hologram device, and projector. The display device 1860 may include touch circuitry adapted to detect a touch, or sensor circuitry (e.g., a pressure sensor) adapted to measure the intensity of force incurred by the touch.

The audio module 1870 may convert a sound into an electrical signal and vice versa. The audio module 1870 may obtain the sound via the input device 1850 or output the sound via the sound output device 1855 or a headphone of an external electronic device 1802 directly (e.g., wired) or wirelessly coupled with the electronic device 1801.

The sensor module 1876 may detect an operational state (e.g., power or temperature) of the electronic device 1801 or an environmental state (e.g., a state of a user) external to the electronic device 1801, and then generate an electrical signal or data value corresponding to the detected state. The sensor module 1876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1877 may support one or more specified protocols to be used for the electronic device 1801 to be coupled with the external electronic device 1802 directly (e.g., wired) or wirelessly. The interface 1877 may include, for example, a high-definition multimedia interface (HDMI), a universal serial bus (USB) interface, a secure digital (SD) card interface, or an audio interface.

A connecting terminal 1878 may include a connector via which the electronic device 1801 may be physically connected with the external electronic device 1802. The connecting terminal 1878 may include, for example, an HDMI connector, a USB connector, an SD card connector, or an audio connector (e.g., a headphone connector).

The haptic module 1879 may convert an electrical signal into a mechanical stimulus (e.g., a vibration or a movement) or an electrical stimulus which may be recognized by a user via tactile sensation or kinesthetic sensation. The haptic module 1879 may include, for example, a motor, a piezoelectric element, or an electrical stimulator.

The camera module 1880 may capture a still image or moving images. The camera module 1880 may include one or more lenses, image sensors, image signal processors, or flashes. The power management module 1888 may manage power supplied to the electronic device 1801. The power management module 1888 may be implemented as at least part of, for example, a power management integrated circuit (PMIC).

The battery 1889 may supply power to at least one component of the electronic device 1801. The battery 1889 may include, for example, a primary cell which may not be rechargeable, a secondary cell which may be rechargeable, or a fuel cell.

The communication module 1890 may support establishing a direct (e.g., wired) communication channel or a wireless communication channel between the electronic device 1801 and the external electronic device (e.g., the electronic device 1802, the electronic device 1804, or the server 1808) and performing communication via the established communication channel. The communication module 1890 may include one or more communication processors that may be operable independently from the processor 1820 (e.g., the AP) and supports a direct (e.g., wired) communication or a wireless communication. The communication module 1890 may include a wireless communication module 1892 (e.g., a cellular communication module, a short-range wireless communication module, or a global navigation satellite system (GNSS) communication module) or a wired communication module 1894 (e.g., a local area network (LAN) communication module or a power line communication (PLC) module). A corresponding one of these communication modules may communicate with the external electronic device via the first network 1898 (e.g., a short-range communication network, such as BLUETOOTH™, wireless-fidelity (Wi-Fi) direct, or a standard of the Infrared Data Association (IrDA)) or the second network 1899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that may be separate from each other. The wireless communication module 1892 may identify and authenticate the electronic device 1801 in a communication network, such as the first network 1898 or the second network 1899, using subscriber information (e.g., international mobile subscriber identity (IMSI)) stored in the subscriber identification module 1896.

The antenna module 1897 may transmit or receive a signal or power to or from the outside (e.g., the external electronic device) of the electronic device 1801. The antenna module 1897 may include one or more antennas, and, therefrom, at least one antenna appropriate for a communication scheme used in the communication network, such as the first network 1898 or the second network 1899, may be selected, for example, by the communication module 1890 (e.g., the wireless communication module 1892). The signal or the power may then be transmitted or received between the communication module 1890 and the external electronic device via the selected at least one antenna.

Commands or data may be transmitted or received between the electronic device 1801 and the external electronic device 1804 via the server 1808 coupled with the second network 1899. Each of the electronic devices 1802 and 1804 may be a device of a same type as, or a different type, from the electronic device 1801. All or some of operations to be executed at the electronic device 1801 may be executed at one or more of the external electronic devices 1802, 1804, or 1808. For example, if the electronic device 1801 should perform a function or a service automatically, or in response to a request from a user or another device, the electronic device 1801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1801. The electronic device 1801 may provide the outcome, with or without further processing of the outcome, as at least part of a reply to the request. To that end, a cloud computing, distributed computing, or client-server computing technology may be used, for example.

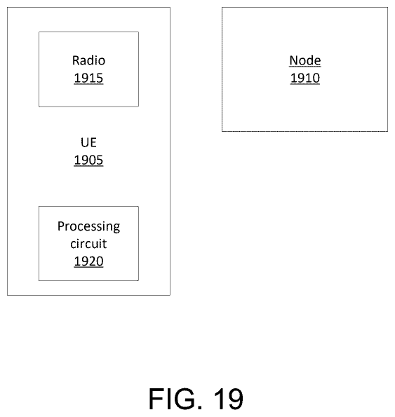

FIG. 19 is a block diagram illustrating a system including a UE and a network node, according to an embodiment.

Referring to FIG. 19 a system including a UE 1905 and a network node (gNB) 1910, in communication with each other, may be provided. The UE may include a radio 1915 and a processing circuit (or a means for processing) 1920, which may perform various methods disclosed herein, e.g., the methods illustrated in FIGS. 16-17. For example, the processing circuit 1920 may receive, via the radio 1915, transmissions from the gNB 1910, and the processing circuit 1920 may transmit, via the radio 1915, signals to the gNB 1910.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
extracting a plurality of video frames including at least a first frame and a second frame;
generating a predicted soft volume for the second frame;
generating a weight map of pixels for the first frame;
combining the predicted soft volume for the second frame with the weight map of pixels for the first frame to generate combined predictions for the output frame; and
generating a video including the combined predictions for the output frame.

2. The method of claim 1, wherein the combined predictions for the output frame are generated based on, at least, a per-pixel scalar weight output of the predictions from the second frame using the weight map of pixels for the first frame.

3. The method of claim 1, wherein the weight map of pixels for the first frame is obtained by spatially filtering a plurality of prediction channels in soft volume prediction for each pixel.

4. The method of claim 1, wherein the first frame is a combined output frame of a previous frame, and
wherein the second frame is a current frame.

5. An apparatus comprising:
a processor; and
a memory coupled to the processor, wherein the processor is configured to:
extract a plurality of video frames including at least a first frame and a second frame;
generate a predicted soft volume for the second frame;
generate a weight map of pixels for the first frame;
combine the predicted soft volume for the second frame with the weight map of pixels for the first frame to generate combined predictions for the output frame; and
generate a video including the combined predictions from the output frame.

6. The apparatus of claim 5, wherein the processor is further configured to generate the combined predictions for the output frame based on, at least, a per-pixel scalar weight output of the predictions from the second frame using the weight map of pixels for the first frame.

7. The apparatus of claim 5, wherein the weight map of pixels for the first frame is obtained by spatially filtering a plurality of prediction channels in soft volume prediction for each pixel.

8. The apparatus of claim 5, wherein the first frame is a combined output frame of a previous frame, and the second frame is a current frame.

9. A method comprising:
extracting a plurality of video frames including at least a first frame and a second frame;
generating predicted soft volumes for the first frame and the second frame;
applying a filter configured to combine the predicted soft volumes for the first frame and the second frame using a trainable operator, thereby generating a fused output for at least one of the first frame or the second frame;
generating a final output frame from the fused output; and
generating a video including the final output frame.

10. The method of claim 9, wherein the filter is configured to operate in a recurrent training mode by:
generating a multiplicative operator based on the predicted soft volume of the second frame and a fused prediction from the first frame;
applying the multiplicative operator to transform the fused prediction from the first frame into a transformed prediction for the second frame; and
computing a Softmax cross-entropy loss between the transformed prediction and a ground truth label of the second frame.

11. The method of claim 9, wherein the filter is configured to operate in a recurrent inference mode by reintroducing a fused output of the first frame together with the predicted soft volume of the second frame to generate a new fused output for the second frame without additional training.

12. The method of claim 9, wherein the filter is configured to operate in a non-recurrent mode by combining the predicted soft volume of the first frame, before it has been fused, with the predicted soft volume of the second frame to generate the fused output.

13. The method of claim 9, wherein the trainable operator is generated by combining the predicted soft volume of the second frame with the fused output of the first frame, and is applied to the predicted soft volume of the second frame.

14. The method of claim 9, wherein the trainable operator is combined with the second frame's predicted soft volume according to a weighted function that includes a max-pooling operation on a Softmax function of the operator.

15. The method of claim 14, wherein the filter is configured to compute an enhanced prediction of the second frame by convolving a weighted combination of the operator and the second frame's predicted soft volume, and applying an Argmax function to select a class label per pixel.

16. An apparatus comprising:
a processor; and
a memory coupled to the processor;
wherein the processor is configured to:
extract a plurality of video frames including at least a first frame and a second frame;
generate predicted soft volumes for the first frame and the second frame;
apply a filter configured to combine the predicted soft volumes of the first frame and the second frame using a trainable operator, thereby generating a fused output for at least one of the first frame or the second frame;
generate a final output frame from the fused output; and
generate a video including the final output frame.

17. The apparatus of claim 16, wherein the filter is configured to operate in a recurrent training mode by:
generating a multiplicative operator based on the predicted soft volume of the second frame and a fused prediction from the first frame;
applying the multiplicative operator to transform the fused prediction from the first frame into a transformed prediction for the second frame; and
computing a Softmax cross-entropy loss between the transformed prediction and a ground truth label of the second frame.

18. The apparatus of claim 16, wherein the filter is configured to operate in a recurrent inference mode by reintroducing a fused output of the first frame together with the predicted soft volume of the second frame to generate a new fused output for the second frame without additional training.

19. The apparatus of claim 16, wherein the filter is configured to operate in a non-recurrent mode by combining the predicted soft volume of the first frame, before it has been fused, with the predicted soft volume of the second frame to generate the fused output.

20. The apparatus of claim 16, wherein the trainable operator is generated by combining the predicted soft volume of the second frame with the fused output of the first frame, and wherein the processor is configured to apply the trainable operator to the predicted soft volume of the second frame.

21. The apparatus of claim 16, wherein the trainable operator is combined with the second frame's predicted soft volume according to a weighted function that includes a max-pooling operation on a Softmax function of the operator.

22. The apparatus of claim 21, wherein the filter is configured to compute an enhanced prediction of the second frame by convolving a weighted combination of the operator and the second frame's predicted soft volume, and applying an Argmax function to select a class label per pixel.
